(19) United States
(12) Patent Application Publication
(10) Pub. No.: US 2008/0209001 A1
(43) Pub. Date: Aug. 28, 2008

(54) Media approval method and apparatus

(76) Inventors: Kenneth James Boyle, Cobb County, GA (US); Naveed Ashraf, Atlanta, GA (US)

Correspondence Address: Joseph J. Laks;Thomson Licensing LLC, 2 Independence Way, Patent Operations, PO Box 5312, PRINCETON, NJ, 08543, US

(21) Appl. No.: 11/903,309

(22) Filed: Sep. 21, 2007

Related U.S. Application Data
(60) Provisional application No. 60/903,928, filed on Feb. 28, 2007.

(51) Int. Cl. G06F 15/16

(52) U.S. Cl. 709/207

(57) ABSTRACT

An apparatus (180) for managing media approval messages in an advertising system (100) includes an approval module (182) that stores information identifying approvers for a piece of media content. A message module (185) routes a first message seeking an approval decision for media content to at least one approver in accordance with the media content sought to be approved. A rules-based module (184) prescribes routing of at least one second message launched by the message module to at least one recipient depending on the action taken by an initial approver for a particular advertisement.

### CROSS-REFERENCE TO RELATED APPLICATIONS

This application claims priority under 35 U.S.C. 119(e) to U.S. Provisional Patent Application Ser. No. 60/903,928 filed Feb. 28, 2007, the teachings of which are incorporated herein.

### TECHNICAL FIELD

This invention relates to a technique for enabling approval of media within a communications network.

### BACKGROUND ART

Today, many businesses have geographically disparate locations. For example, a business can have a corporate headquarters in one location, and or more sales offices at different locations. Indeed, very large businesses can have a corporate office, various regional offices and a plurality of sales offices, all at separate locations. Within one or more of such offices, one or more individuals can have responsibility for the creation and distribution of media content such as advertising.

For example, a marketing manager at one location might seek to place an advertisement of a certain type in one or more media venues, say television, radio, Internet, and/or newspaper. If the advertising copy already exists and has undergone the necessary approvals by various groups with review responsibility, such as brand marketing, legal, and sales, for example, then distribution of the advertisement might only involve acquiring the desired advertising space in the appropriate venue(s). However, if the advertising copy does not exist, or has been substantially modified, then the new copy must undergo approval by the appropriate groups within the organization.

Co-pending U.S. patent application Ser. No. 11/215,907, filed 31 Aug. 2005, (published 1 Mar. 2007 as Publication No. 20070050372A1) and incorporated by reference herein, describes system for creating, managing, and publishing advertisements. As described in the '907 application, a user can input a request to the advertising publishing system to publish an advertisement in one or more media venues. After making the request, the user will identify an advertisement for publication. Part of the user identification process can include selecting an existing advertisement and then making various changes, including those necessary to make the advertisement suitable for the intended media venue. The system reviews the user-identified advertisement for formatting. If the advertisement lacks the appropriate formatting; the system will notify the user who can then view the advertisement and revise or delete it as appropriate. Advertisements determined by the system to have the appropriate formatting will undergo rendering prior to scheduling for playout.

The approval process described in the '907 application process does not take into account the various groups, and in particular, the various individuals within such groups, that all have an interest in the advertisement as ultimately as published. For example, in many large organizations, all advertisements typically must undergo a review by the law department to insure that the advertisement satisfies legal requirements. Similarly, many large organizations also require all advertisements to undergo review by the group responsible for managing corporate branding to assure consistent use of the organization's identity. Other groups, such as sales and marketing, can have a stake in the advertising approval process.

Thus, a need exists for a technique for managing media publication approval.

### BRIEF SUMMARY OF THE INVENTION

Briefly, in accordance with a preferred with a preferred embodiment of the present principles, there is provided a method for managing media approval messages. The method commences by routing a first message seeking an approval decision for media to at least one approver in accordance with the media to be approved. The method further comprises the step of routing at least one second message to at least one recipient identified by at least one rule established in accordance with the approval decision made by the at least one approver.

The initial routing of the approval message, based on the media to be approved, and the subsequent routing of messages based on one or more rules established in accordance with the initial approver's decision, enables automation of the approval process. Thus, an individual seeking approval for a particular advertisement need not know the identity of the approver(s) a priori because the particular advertisement will have associated with it information identifying the necessary approver(s).

Further, using a rules-based approach to route subsequent messages assures that various stake holders in the approval process will receive requests for approval when appropriate. For example, if the initial approver rejected the approval request, then the rules-based approach of the present principles might dictate that a message get sent back to the requesting party. Conversely, if the initial approver approved the media request, then the rules-based approach would establish the recipients for subsequent messages. For instance, if the media request only requires approval by the initial approver, a subsequent message could get sent to initiate ad playout. However, if the media request requires additional approvals, one or more subsequent messages will get sent to the recipient(s) who must grant such subsequent approvals. The approval action taken by such subsequent approver(s) also undergo analysis using the rules-based approach to determine the recipients of further messages. In this way, the initial requestor need not concern itself with identity of the approvers and the particular order of approval messages because the rules-based approach handles these matters.

### BRIEF SUMMARY OF THE DRAWINGS

FIG. 1 depicts a block schematic diagram of a system for managing media content approval in accordance with an illustrative embodiment of the present principles;

FIG. 2 depicts a block schematic diagram of a message approval module comprising a portion of the system of FIG. 1;

FIG. 3 depicts in flow chart form the process of managing media approval messages in accordance with the present principles; and

FIG. 4 depicts an advertisement and associated approver list associated with the system of FIG. 1.

### DETAILED DESCRIPTION

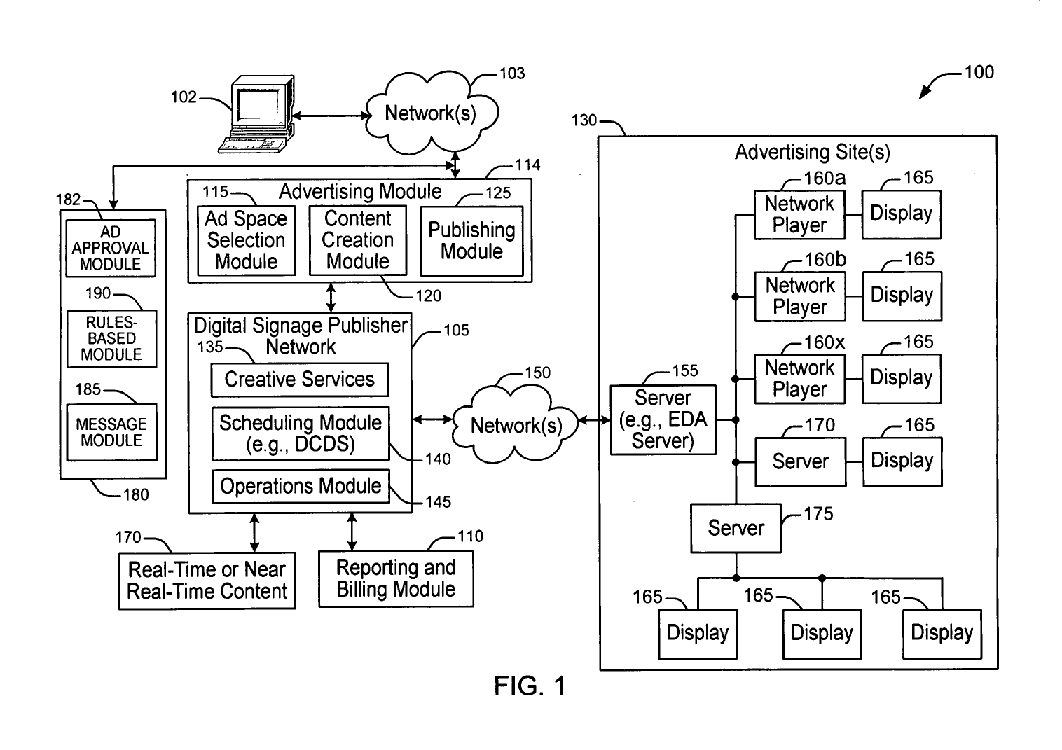

FIG. 1 shows a block diagram of a system 100 for distributing media that facilitates handling of messages seeking approval of media, for example, advertising, according to an illustrative embodiment of the invention. The system 100 includes at least one user computer 102 in communication with an advertising module 114 via one or more network(s) 103. The advertising module 114 typically includes a server (not shown) operable to run one or more software applications, and includes an ad space selection module 115, a content creation module 120, and a publishing module 125. Generally, the ad space selection module 115, content creation module 120, and publishing module 125 provide the user with web-based interfaces to enable a user, via the computer 102, to search and select ad space and to create, manage and publish digital content, including but not limited to advertisements. The subsequent reference herein to approval of ads should be understood to encompass the approval of other types of digital content as well.

The ad space selection module 115, content creation module 120, and publishing module 125 reside in computer software within the advertising module 114 and are accessible by a user via the computer 102 over the network(s) 103, which typically, although not necessarily encompasses the Internet. In such an embodiment, a user can communicate with the advertising module 114 using an Internet browser on the computer 102 that permits the user to view HTML pages, which are preferably displayed in graphical format. Well-known web browsers such as Netscape navigator and Microsoft Explorer automatically format data that is programmed in the HTML language according to well-known protocols. Information gets exchanged back and forth between the computer 102 and the advertising module 114 according to a well-known protocol, such as the Hyper-Text Transport Protocol (HTTP), although other protocols, such as FTP, are also available.

The computer 102 can exchange messages with one or one or more servers within the advertising module 114, which can include a web server and/or HTTP server. As is well known in the art, a web server can have installed files that include HTML documents or which can dynamically generate HTML documents for display on a screen of the computer 102. Thus, without the need for any hardware or software, other than a standard personal computer and a common web browser, a user can access the ad space selection module 115, content creation module 120, and publishing module 125 residing in computer software within the advertising module 114.

The computer 102 can include various standard components, including a central processing unit and associated read-only memory (ROM) (not shown), both of which are connected via a data and address bus to a random access memory (not shown). The computer 102 typically includes an input/output interface (I/O) and one or more I/O device(s) connected to the RAM, the CPU and the ROM via a bus. The CPU controls the I/O interface to control any corresponding I/O devices. Typical I/O devices can include a video display, a keyboard, a scanner, and a mouse or joystick or other input or output devices (all not shown). The computer 102 can also include one or more storage devices, which can comprise conventional devices for storing data, such an external hard disk. The computer 102 further includes a system for connection to the communications network(s) 103, such as a modem or a network interface card. The computer 102, as described, thus possesses the same elements as any typical personal computer capable of accessing a network, such as a WAN, LAN or the Internet.

In addition to the various hardware-elements described above, the computer typically has an installed operating system, such as Microsoft Windows®, available from Microsoft, Redmond, Wash., or other well known operating system, that controls various software applications installed on the computer. Such applications can include programs for data management, storage and retrieval, a web browser application that is capable of formatting HTML documents, a communications program capable of controlling communications between the computer 102 and the network(s) 103.

As shown in FIG. 1, the advertising module 114 communicates with a digital signage publisher network 105, which can include creative services 135, a scheduling module 140, and an operations module 145. Generally, the digital signage publisher network possesses the capability of publishing advertisements created using the advertising module 114, whereas the scheduling module 140 serves to transmit such user-generated ads, created using the advertising module 114, to one or more advertising sites 130 via one or more networks 150. The scheduling module 140 controls the display of such user-created ads on the advertising sites 130 such that the ads undergo display based on the ad space purchased by the user via the ad space selection module 115. The scheduling module 140 further communicates in real-time or near real-time scheduling information to the advertising module 114, which includes ad space availability information. This permits the advertising module 114, and more specifically, the ad space selection module 115, to display up-to-date information detailing what ad space is available in the system 100.

The digital signage publisher network 105 can also include the operations module 145, which can include software and/or hardware for monitoring the status of user-generated ads playing (or having already completed playing) at one or more advertising sites 130. The operations module 145 can also include reporting and billing applications to bill users for ads played at advertising sites. According to an aspect of the invention, the operations module 145 can communicate with a reporting and billing module 110, which can be used to automatically generate bills for payment by those using the system 100 to create and publish ads. It will be appreciated that because each ad space and/or user can correspond to different charges and/or rates, the operations module 145 should be operable to track billing for all advertisements played at any ad site. This can also be desirable for billing purposes should one or more ads be unplayable by the system 100 due, for instance, to an advertising site 130 being off-line or otherwise unavailable.

The digital signage publisher network 105 can also include a creative services unit 135, which can include professional editing personnel and/or software, and media (e.g., templates, backgrounds, pictures, and the like) that is used to aid in the publication of ads made by users using the advertising module 114. The creative services 135 unit can approve user-created ads prior to the scheduling module 140 forwarding the ads to advertising sites 130. This approval can be required not only for the content of the ads, but also for format, including length, size, file type, and the like. Additionally, creative services unit 135 might want to preview user created ads to ensure that they appear professionally formatted or rendered. Those skilled in the art will appreciate that the creative services unit 135 is optional

The system 100 shown in FIG. 1 also includes real-time or near real-time content 170. The real-time or near real-time content 170 can be transmitted to advertising sites 130 by the scheduling module 140 along with user-created ads. According to an aspect of the invention, the scheduling module 140 can transmit real-time or near real-time content 170 for display during gaps in the playing of ads. The real-time or near real-time content 170 can be inserted into ads, such that the ads include the real-time or near real-time content 170 along with stored content. As an illustrative example, a user wishing to advertise a product or service at a sporting venue, where the advertisement includes real-time streaming sports scores in a ticker-type display. Additionally, to ensure seamless integration of the real-time or near-real time content 170 with stored content, creative services 135 can be used to generate dynamic graphics that integrate the two digital media components.

As shown in FIG. 1, the digital signage publisher network 105 can be in communication with one or more media outlets, or advertising sites 130, via one or more networks 150, which can include satellite networks, cable networks, the Internet, local-area networks (LANs), or any other network capable of transmitting video and/or audio content to near or remote locations. According to one embodiment, the digital signage publisher network 105 can be located at a single facility and can transmit user-created ads to advertising sites 130. Through customization the content can be physically delivered through various mechanisms such as FTP(s), HTTP(s), pinnacle, VBase, Stratacache, satellite or terrestrial networks.

Each advertising site 130 can include a server 155, such as an EDA server, for receiving content provided by the digital signage publisher network. The server 155 distributes content, including user-generated ads to displays 165 via one or more network players 160a-160x and/or servers 170, 175, as is known in the art. The displays 165 can include Plasma, LCD, DLP, or CRT displays, or the like, located at an advertising site. Because each advertising site 130 only requires a single server, one or network players and one or more displays, each advertising site 130 can incur very little expenditure in setting up a digital advertising system. Additionally, because the scheduling of content, including user-generated ads, is managed by the scheduling module 140, very little setup or maintenance of the advertising site 130 is required.

As thus described, the system 100 possesses the elements of the media distribution system described in co-pending U.S. patent application Ser. No. 11/215,907, incorporated by reference herein. To enable the user to obtain the necessary approvals of the advertisements created by the advertising module 114, the system 100 advantageously includes a message approval module 180 in accordance with the present principles. As described in greater detail hereinafter, the message approval module 180 manages the communication of approval messages generated by the user to seek approval for the created advertising. Heretofore, to the extent that the user needed approval prior to the actual publication of an advertisement, the user need to manually send an approval message to the requisite approver(s). Different advertisements can require different approvers. Moreover, the sequence of approval messages can differ depending on the approvals previously granted (or not granted) in a previous message. The message approval module 180 manages such messages to relieve the burden on the user.

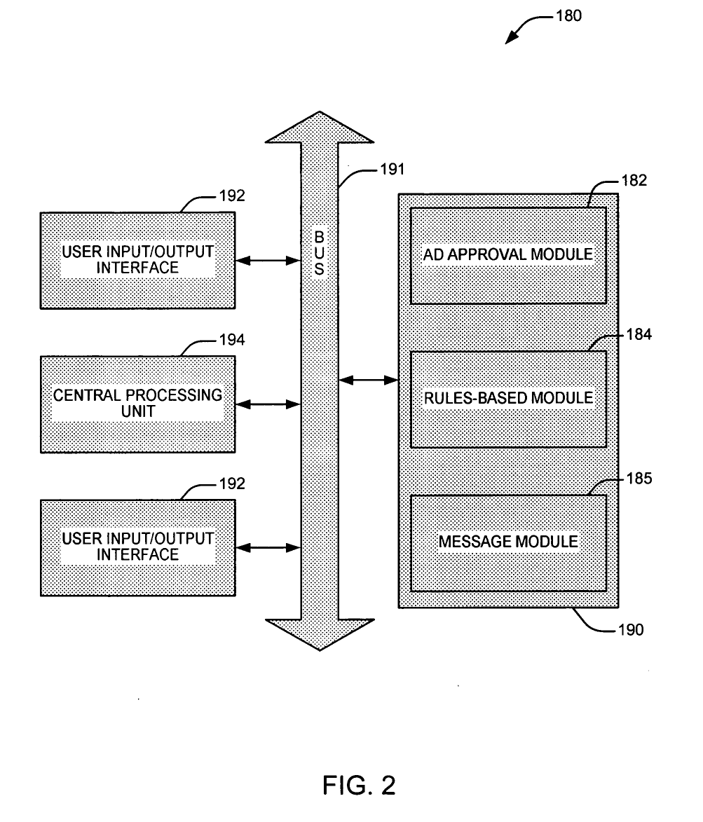

As depicted in FIG. 1, the message approval module 180 contains three sub-modules, an ad approval module 182, a rules-based module 184 and a message module 185 described in more detail in FIG. 2. Referring to FIG. 2, the ad approval module 182 and the rules-based module 184 typically comprise relationship tables in one or more databases (not shown). Referring back to FIG. 1, the ad approval module 182 stores information about the advertisements created by the content creation module 120 of FIG. 1 and, in particular a list of the individuals and/or entities responsible for their approval. Stated another way, for each advertisement, the ad approval module 182 will store information identifying the requisite approvers. For example, an advertisement provided by the content creation module 120 that had previously been approved typically will require fewer approvals as compared to an advertisement not previously published. Different media venues could also require different approvals. Different products or services that make use of the same advertisement can also require different approvals.

The rules-based module 184 typically comprises a table of rules that prescribe the subsequent actions depending on the action taken by an initial approver for a particular advertisement. As discussed previously, different advertisements can require different approvals and the approval or rejection by one approver will affect the sequence of subsequent approvals. For example, content that had previously gained approval by the required approvers for a first advertising venue generally will not require the same approvals for use in a different media venue. Thus, an advertisement that appeared in a newspaper might only require the approval of the advertising copy department for playout on the Internet. Manually keeping track of who must approve a particular advertisement as well as the sequence of such approvers can prove especially challenging. In accordance with the present principles, the rules-based module 184 tracks the approval messages and determines the subsequent recipient(s) for sending approval messages based on the particular content, and action taken by prior approvers. The message module 185 serves to launch media approval messages, including an initial approval message, and subsequent messages developed by the rules-based module 184.

FIG. 2 depicts the message approval module 180 of FIG. 1 in greater detail. The message approval module comprises a storage unit 190, such as a disk drive, or a RAID array, that stores software performing the functions of the ad approval module 182, the rules-based module 184 and the message module. A bus 191 couples the database 190 to a user input/output 192, a central processing unit 194, and a communications interface 196. The central processing unit 194 possesses a computer operating system, together with one or more applications programs to enable the exchange of information between the database 190 and the communications interface 196. Such programs also enable the information exchange between the message approval module 180 and each of the advertising module 115 and the network 103, both of FIG. 1 via the communications interface 196. The user input/output interface 192 enables the central processing unit 194 to communicate with one or more input/output devices, such as a keyboard, a mouse, a monitor and/or a touch screen, to enable a user to enter information into, and receive information from the message approval module.

The message module 185 typically can include one or application programs executed by the central processing unit 194 of FIG. 2 for managing electronic mail (e-mail) communication to enable the central processing unit generate and route media approval messages. Such an electronic mail management program could comprise Microsoft Outlook® available from Microsoft Corporation, Redmond, Wash. Other electronic mail management programs exist could serve this function as well. The processing unit 194 can also execute one or more applications programs for logging and tracking of activities for use by systems administration. Such programs could comprise part of the message module 185.

The elements thus far described for the message approval module 180, namely, the storage element 190, the bus 191, the user input/output interface, the central processing unit 194 and the communications interface 196 could collectively take the form of a personal computer. Such a personal computer could make user of either a Windows®-based or Macintosh®-based operating systems, available from Microsoft or Apple Computers. Other operating systems for personal computer also exist. Configuring the message approval module 180 as an appropriately programmed personal computer also enables the use of a variety of web browser technologies, such as Internet Explorer, available from Microsoft, Firefox, available from Mozilla Corporation, Mountain View, Calif., and Safari, available from Apple Computer. Using web-based technology allows design of the application interface to ensure that the complex tasks are simplified to enable maximum productivity.

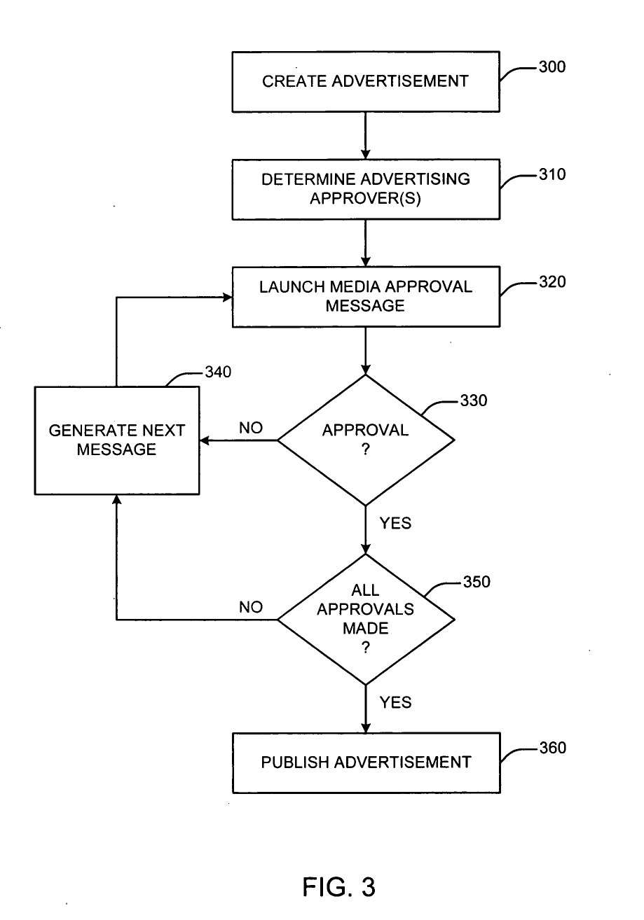

FIG. 3 depicts in flow chart form the overall operation the system 100 of FIG. 1, including the message approval module 180 in accordance with the present principles. The method commences upon execution of step 300 during which a user creates an advertisement in the manner discussed previously, using the advertising module 115 of FIG. 1.

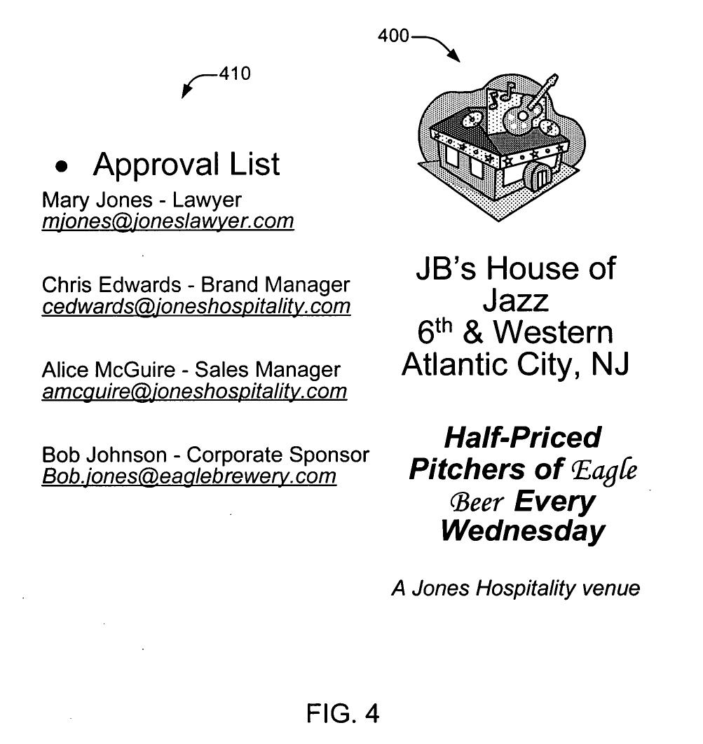

FIG. 4 illustratively depicts an illustrative advertisement 400 created during step 300 of FIG. 3. For purposes of simplicity, the advertisement 400 comprises an illustration and accompanying text advertising “JB's House of Jazz”, an entertainment venue managed by Jones Hospitality. A more sophisticated advertisement could include animation, live or pre-recorded video, audio or any combination thereof. Further, the advertisement 400, if destined for distribution over the Internet, could also include one or more hyperlinks.

In accordance with the present principles, the advertisement 400 of FIG. 4 includes an associated approval list 410 that identifies the entities and/or individuals responsible for the approval of the advertisement. In the illustrative embodiment, the following individuals must approve this advertisement:
Mary Jones Lawyer
Chris Edwards—Brand Manager
Alice McGuire—Sales Manager
Bob Johnson—Corporate Sponsor
   The approvers have associated electronic mail addresses which each take the conventional form of name@domain.com. In some instances, the order of the approvers will prove significant and the approval list 410 will contain an indication of the order of approvers.

The number of approvers and the entities they represent can vary depending on various factors, such as the product or service being advertised, the particular media venues, and whether the advertisement had previously undergone publication. In the illustrative embodiment, a corporate sponsor, in this example Eagle Brewery, has agreed to co-sponsor this advertisement and thus approval by a responsible individual at that entity is also required.

Referring to FIG. 3, following step 300 step 310 undergoes execution to determine the necessary approvers. Typically, determining the necessary approver entails obtaining the approval list 410 associated with the advertisement 400. In some instances, an advertisement might lack an approval list. Under such circumstances, approval would depend on a default approval list maintained by the ad approval module 182 of FIG. 1. Following the execution of step 310, step 320 undergoes execution and the message approval module 180 of FIGS. 1 and 2 will send at least one media approval messages to the first of the approvers determined during step 310, assuming multiple approvers and a particular approver order. If no order exists, the launching of two or more media approval messages could occur in parallel. In this way, the originator of the content does not need to specifically identify the approver(s) as the ad approval module 182 maintains such information.

Each media approval message launched during step 320 will have either a copy of the advertisement for approval within the message itself or a hyperlink to that advertisement. Providing a link reduces the overall size of the message. In this way an individuals will receive one or more e-mails and will interact through such emails that contain links to, and possible images of, the advertisement. As described hereinafter, e-mails get generated during various activities, such as uploading a new media approval message for review, commenting on an existing message, media approvals and declines. External users can optionally create a password from their e-mail ID and self enroll allowing web based access into the system 100 and additional self service password recovery. Internal users will utilize IDs and passwords to enable auditing and enforce roles and security. Typically, the system 100 of FIG. 1 will make use role-based security. Users get be assigned various roles allowing or denying access to certain system features such as approver, reviewer, commenter, administrator, etc.

In practice, reliable uploading of large media files will through a-web browser (HTTP) with status and feedback. Optionally, uploads can occur via FTP folder. The system 100 of FIG. 1 has been designed with staging folders that move media, once uploaded and registered, behind the firewall to ensure that no media is accessible directly through URLs once uploaded. Additionally IDs and self expiring emails help secure the system and the media stored within it.

Each approver destined to receive the message launched during step 320 of FIG. 3 will possess appropriate software for accessing to the message, as well s software capable of playing media clips, such as, but not limited to QuickTime from Apple Computer and Windows Media Player from Microsoft. Approvers can select the format of the advertisement for preview playback. For example, an approver primarily interested in just the content might seek low resolution playback. In practice, uploading files causes automatic rendering into a lower resolution format for web viewing, including thumbnails. These formats can range from HD (720p, 1280i) and SD (MPG) to compressed formats such as .mov, .wmv and more.

Step 330 follows next during which the rules-based module 184 of FIG. 1 analyzes each message returned from an approver in response to the approval message(s) launched during step 320. In practice, an approver receiving a media approval message will accept or reject the media content, for example, the advertisement 400 of FIG. 4. While the approver could simply comment on the advertisement without necessarily explicitly granting an approval or rejection, for ease of message handling, any return message from an approver not containing an explicit approval will be treated as a rejection message.

Whether or not the approver granted approval determines whether execution of steps 340 or 350 undergo execution. An explicit approval from an approval in a return message will trigger execution of step 350. Otherwise, step 340 undergoes execution during which the rules-based module determines the recipient and content of a next message for launching during re-execution of step 320. Thus for example, if the returned message from an approver contained a rejection, the rules-based module 184 typically would formulate a message for transmission back to the individual(s) who sought approval for the advertisement. The recipient(s) of this message could then take the appropriate action to address the rejection.

In the event of an approval, as determined during step 330, then step 350 undergoes execution during which a determination is made whether all approvals have been granted. For example, an advertisement might require only a single approval, especially if the advertisement had been published previously. If all approvals have been granted, then the advertisement undergoes publication during step 360. The publication of the advertisement during step 360 could require certain operations in advance of the advertisement actually undergoing playout. For example, the advertisement could require rendering and/or formatting. Operations of this nature which do not necessarily change the “look” or “feel” of the advertisement can occur during step 360 of FIG. 3. Upon determining the need for additional approvals during execution of step 350, then step 340 undergoes execution, and the rules-based module 184 will generate the appropriate message(s) for launching during step 320 to the next successive approver(s). The re-execution of steps 320, 330, 340 and 350 will continue until all approvals have been granted. In the event this process proceeds for an extended interval, a timer (not shown) could time out and terminate execution of the process of FIG. 3.

As described above, the message approval module 180 within the system 100 of FIG. 1 advantageously automates the process of approving content such as advertising, especially in the event of a need for multiple approvals. In this way, multiple organizations can collaborate on a project or media level as defined by a project/campaign manager. Typically, all aspects of software and hardware maintenance, bandwidth and storage capacity planning including upgrades and changes are managed by the system 100. With some customizations Meta data collection can be supported that could be delivered in various file formats (XML) with the media to the distribution platform.

The foregoing describes a technique for managing the media approval messages in a system for creating and publishing advertisements,

1. A method for managing media approval messages, comprising the steps of:
routing a first message seeking an approval decision for media content to at least one approver in accordance with the media content sought to be approved; and
routing at least one second message to at least one recipient identified in accordance with at least one rule established in accordance with the decision made by the at least one approver.

2. The method according to claim 1 wherein the at least one recipient must further approve the media content.

3. The method according to claim 1 wherein the first message originates from a media content creator.

4. The method according to claim 3 wherein the second message is routed to the media content creator upon rejection by the at least one approver.

5. The method according to claim 3 wherein the at least one recipient of the second message comprises an additional approver.

6. The method according to claim 1 wherein the media content sought to be approved comprises an advertisement.

7. The method according to claim 1 wherein the routing of the first message occurs in accordance with a default approval list in the event the media content does not contain approval information.

8. The method according to claim 4 wherein the advertisement includes a list of approvers.

9. Apparatus for managing media approval messages, comprising:
an approval module for storing information identifying requisite approvers for a piece of media content;
a message module for routing a first message seeking an approval decision for media content to at least one approver in accordance with the media content sought to be approved;
and for routing at least one second message to at least one recipient identified in accordance with at least one rule established in accordance with the decision made by the at least one approver;
a rules-based module that prescribes the routing of the at least one second message generated depending on the action taken by an initial approver for a particular advertisement.

10. The apparatus according to claim 9 wherein the approval module, the message module and the rules-based module collectively comprise a personal computer.

11. The apparatus according to claim 9 wherein the information stored by the approval is obtained from the piece of media content.

12. The apparatus according to claim 9 wherein the approval module stores a default list of approvers.

13. The apparatus according to claim 7 wherein the first and second messages comprise electronic mail messages.

14. The apparatus according to claim 13 wherein the electronic messages include a copy of the media content to be approved.

15. The apparatus according to claim 13 wherein the electronic messages contain a hyperlink to the electronic content to be approved.
